(19) United States
(12) Patent Application Publication
(10) Pub. No.: US 2002/0116187 A1
(43) Pub. Date: Aug. 22, 2002

(54) Speech detection

(76) Inventor: Gamze Erten, Okemos, MI (US)

Correspondence Address: Mark D. Chuey, Brooks & Kushman P.C., 22nd Floor, 1000 Town Center, Southfield, MI, 48075-1351, US

(21) Appl. No.: 09/971,323

(22) Filed: Oct. 3, 2001

Related U.S. Application Data
(60) Provisional application No. 60/238,560, filed on Oct. 4, 2000.

(51) Int. Cl. G10L 15/20

(52) U.S. Cl. 704/233

(57) ABSTRACT

Speech in the presence of noise is detected by first extracting at least one extracted speech signal from at least one received signal and extracting at least one extracted noise signal from the at least one received signal. A detected speech signal is generated based on both at least one extracted speech signal and on at least one extracted noise signal.

### CROSS REFERENCE TO RELATED APPLICATIONS

This application claims the benefit of U.S. Provisional Application Ser. No. 60/238560 filed Oct. 4, 2000, which is incorporated herein by reference in its entirety.

### BACKGROUND OF THE INVENTION

1. Field of the Invention

The present invention relates to detecting the presence of speech.

2. Background Art

Speech detection is the process of determining whether or not a certain segment of recorded or streaming audio signal contains a voice signal. The voice signal typically is a voice signal of interest which may appear in the presence of noise including other voice signals. Speech detection may be used in a wide variety of applications including speech activated command and control systems, voice recording, voice coding, voice transmitting systems such as telephones, and the like.

A barrier to the proliferation and user acceptance of voice based command and communications technologies has been noise sources that contaminate the speech signal and degrade the quality of speech processing results. The consequences are poor voice signal quality, especially for far field microphones, and low speech recognition accuracy for voice based command applications. The current commercial remedies, such as noise cancellation filters and noise cancelling microphones, have been inadequate to deal with a multitude of real world situations.

Elimination of noise from an audio signal leads to better speech detection. If noise mixed into the signal is reduced, while eliminating little or none of the voice component of the signal, a more straight forward conclusion as to whether a certain part of the signal contains voice may be made.

Speech detection can be based on several criteria. One commonly used criteria is the power of the signal. This approach assumes that the speaker is within a short distance from the microphone so that when the speaker speaks, the power of the signal recorded by the transducer that senses or registers the sound will rise significantly. These methods take advantage of the fact that speech is intermittent. Due to this intermittence, as well as the proximity of the speaker to the microphone, gaps between utterances will contain lower levels of signal power then the proportions that contain speech. A problem with such techniques is that speech itself does not generate a constant power. Thus, the surge in power of the signal will be less for speech that is not voiced. Speech detection based on signal power works best when the noise level is significantly lower then the speech level. However, such techniques tend to fail in the presence of medium or high levels of noise.

### SUMMARY OF THE INVENTION

Speech detection of the present invention relies on characteristics of the estimated speech and on characteristics of estimated noise. Speech detection is based on speech signals and noise signals which are at least partially separated from each other.

A speech detection system is provided. The system includes at least one transducer converting sound into an electrical signal. A voice extractor produces at least one extracted speech signal and at least one extracted noise signal based on the electrical sound signals. A speech detector generates a detected speech signal based on the at least one extracted speech signal and on the at least one extracted noise signal. The speech detector may recognize periods of speech based on at least one property of the extracted speech signal and on at least one corresponding property of the at least one extracted noise signal.

Periods of speech may be recognized based on statistical properties, spectral properties, estimated relative proximity of a speaker to at least two of the transducers, an envelope of the extracted speech signal, signal power, and the like.

In an embodiment of the present invention, the at least one extracted speech signal is divided in time into a plurality of windows. The speech detector generates the detected speech signal based on determining whether or not speech is present in each window. The at least one extracted speech signal may be divided into a plurality of frequency bands with the speech detector determining whether or not speech is present in each frequency band for each window. The detected speech signal may then be based on a combination of the determination for each frequency band for each window.

In another embodiment of the present invention, a variable rate coder changes coding rate for coding the detected speech signal based on a determined presence of speech in the detected speech signal.

In still another embodiment of the present invention, a variable rate compressor changes compression rate for compressing the detected speech signal based on a determined presence of speech in the detected speech signal.

A method of detecting speech in the presence of noise is also provided. At least one signal containing speech mixed with noise is received. At least one extracted speech signal is extracted from the received signal. At least one extracted noise signal is also extracted from the received signal. A detected speech signal is generated based on at least one extracted speech signal and on at least one extracted noise signal.

In an embodiment of the present invention, the detected speech signal includes periods where the extracted speech signal is attenuated.

In another embodiment of the present invention, the detected speech signal includes a likelihood of speech presence.

A method of detecting speech is also provided. At least one noise signal is received. At least one speech signal having a greater content of speech then the at least one noise signal is also received. At least one noise parameter is extracted from the noise signal. At least one speech parameter is extracted from the speech signal. The at least one speech parameter and the at least one noise parameter are compared and the presence of speech is detected based on this comparison.

Another method of detecting speech is provided. A noise signal and a speech signal having a greater speech content then the noise signal are received. The speech signal is divided into a plurality of speech frequency bands. The noise signal is divided into a plurality of noise frequency bands, each noise frequency band corresponding to one of the speech frequency bands. For each speech frequency band, at least one detection parameter is calculated based on at least one property of the speech frequency band and on at least one property of the corresponding noise frequency band. A frequency band output is generated based on the at least one detection parameter.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram of a speech detection system according to an embodiment of the present invention;

FIG. 2 is a block diagram of signal separation according to an embodiment of the present invention;

FIG. 3 is a block diagram of a feed-forward state space architecture for signal separation according to an embodiment of the present invention;

FIG. 4 is a block diagram of a feed-back state space architecture for signal separation according to an embodiment of the present invention;

FIG. 5 is a block diagram of a two transducer voice extractor having a plurality of extracted speech signal outputs according to an embodiment of the present invention;

FIG. 6 is a block diagram of a two transducer voice extractor generating one extracted speech signal and one extracted noise signal according to an embodiment of the present invention;

FIG. 7 is a block diagram illustrating a voice detector according to an embodiment of the present invention;

FIG. 8 is a block diagram illustrating a voice detector using multiple frequency bands according to an embodiment of the present invention;

FIG. 9 is a histogram plot of a typical voice signal;

FIG. 10 is a histogram plot of typical noise signal;

FIG. 11 is a frequency plot of a typical voice signal;

FIG. 12 is a frequency plot of a typical noise signal;

FIG. 13 is schematic diagram illustrating relative transducer placement for proximity-based speech detection according to an embodiment of the present invention;

FIG. 14 is a plot of a noisy speech signal;

FIG. 15 is a plot of a speech detective signal according to an embodiment of the present invention; and

FIG. 16 is a block diagram illustrating compressing or coding according to an embodiment of the present invention.

### DETAILED DESCRIPTION OF THE PREFERRED EMBODIMENT(S)

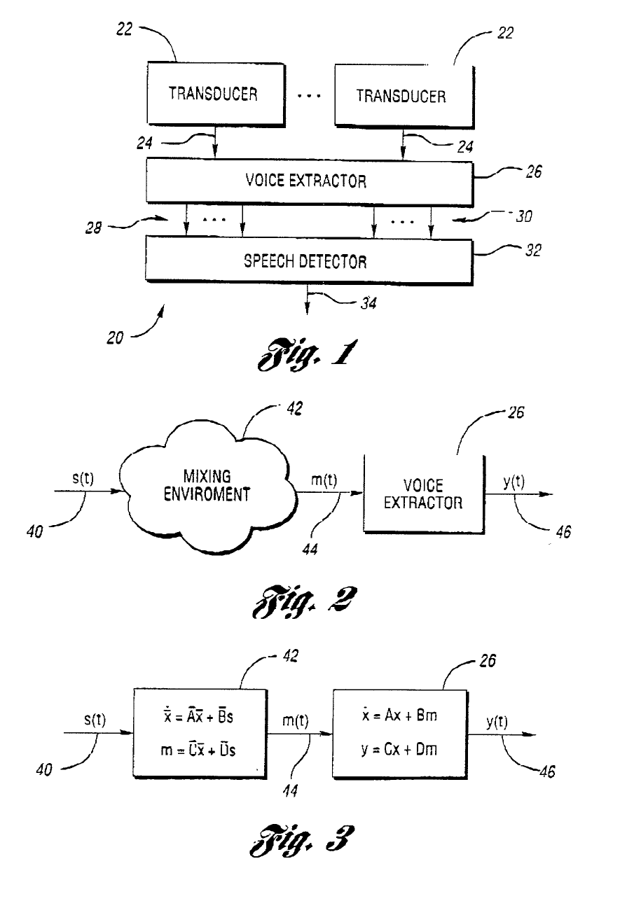

Referring to FIG. 1, a block diagram illustrating a speech detection system according to an embodiment of the present invention is shown. A speech detection system, shown generally by 20, includes one or more transducers 22 converting sound into sound signals 24. Typically, transducers 22 are microphones and sound signals 24 are electrical signals. Voice extractor 26 receives sound signals 24 and generates at least one extracted speech signal 28 and at least one extracted noise signal 30. Extracted speech signals 28 contain a greater content of desired speech then do extracted noise signals 30. Likewise, extracted noise signals 30 contain a greater noise content then do extracted speech signals 28. Thus, extracted speech signals 28 are “speechier” than extracted noise signals 30 and extracted noise signals 30 are “noisier” than extracted speech signals 28. Speech detector 32 receives at least one extracted speech signal 28 and at least one extracted noise signal 30. Speech detector 32 generates detected speech signal 34 based on received extracted speech signals 28 and on extracted noise signals 30.

Detected speech signal 34 may take on a variety of forms. For example, detected speech signal 34 may include one or more extracted speech signals 28, or combinations of extracted speech signals 28, in which periods where speech has not been detected are attenuated. Detected speech signal 34 may also include one or more signals indicating a likelihood of speech presence in one or more extracted speech signals 28 or sound signals 24.

Referring now to FIG. 2, a block diagram of signal separation according to an embodiment of the present invention is shown. Signal separation permits one or more signals, received by one or more sound sensors, to be separated from other signals. Signal sources 40 indicated by s(t), represents a collection of source signals, including at least one desired voice signal, which are intermixed by mixing environment 42 to produce mixed signals 44, indicated by m(t). Voice extractor 26 extracts one or more extracted speech signals 28 and one or more extracted noise signals 30 from mixed signals 44 to produce a vector of separated signals 46 indicated by y(t).

Many techniques are available for signal separation. One set of techniques is based on neurally inspired adaptive architectures and algorithms. These methods adjust multiplicative coefficients within voice extractor 26 to meet some convergence criteria. Conventional signal processing approaches to signal separation may also be used. Such signal separation methods employ computations that involve mostly discrete signal transforms and filter/transform function inversion. Statistical properties of signals 40 in the form of a set of cumulants are used to achieve separation of mixed signals where these cumulants are mathematically forced to approach zero. Additional techniques for signal separation are described in U.S. patent application Ser. Nos. 09/445,778 filed Mar. 10, 2000; 09/701,920 filed Dec. 4, 2000; and 09/823,586 filed Mar. 30, 2001; and PCT publications WO 98/58450 published Dec. 23, 1998 and WO 99/66638 published Dec. 23, 1999; each of which is herein incorporated by reference in its entirety.

Mixing environment 42 may be mathematically described as follows:

[symbol]

=\overline{A} \overline{X}+\overline{B} s

m=\overline{C} \overline{X}+\overline{D} s

Where \overline{A}, \overline{B}, \overline{C} and \overline{D} are parameter matrices and \overline{X} represents continuous-time dynamics or discrete-time states. Voice extractor 26 may then implement the following equations:

\dot{X}=A X+B m

y=C X+D m

Where y is the output, X is the internal state of voice extractor 26, and A, B, C and D are parameter matrices.

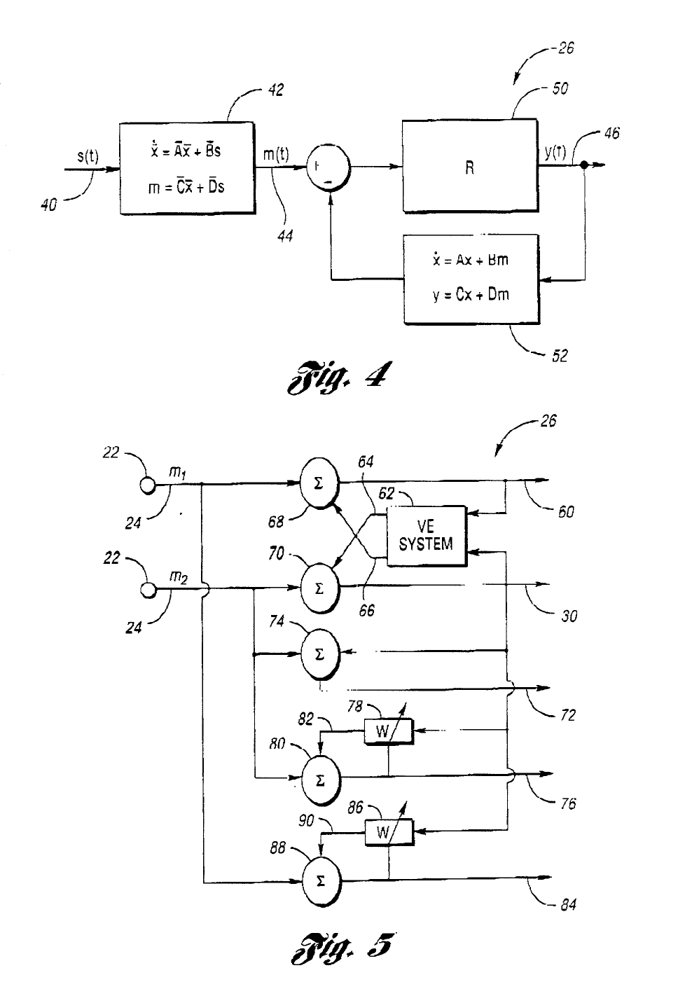

Referring now to FIGS. 3 and 4, block diagrams illustrating state space architectures for signal mixing and signal separation are shown. FIG. 3 illustrates a feedforward voice extractor architecture 26. FIG. 4 illustrates a feedback voice extractor architecture 26. The feedback architecture leads to less restrictive conditions on parameters of voice extractor 26. Feedback also introduces several attractive properties including robustness to errors and disturbances, stability, increased bandwidth, and the like. Feedforward element 50 in feedback voice extractor 26 is represented by R which may, in general, represent a matrix or the transfer function of a dynamic model. If the dimensions of m and y are the same, R may be chosen to be the identity matrix. Note that parameter matrices A, B, C and D in feedback element 52 do not necessarily correspond with the same parameter matrices in the feedforward system.

The mutual information of a random vector y is a measure of dependence among its components and is defined as follows:

$$L ( y ) = {\sum }_{y ∈ y} {p}_{y} ( y ) ln \vert \frac{{p}_{y} ( y )}{{\prod }_{j = l}^{j = r} {p}_{{y}_{j}} ( {y}_{j} )} \vert$$

An approximation of the discrete case is as follows:

$$L ( y ) ≅ {{\sum }_{k = {k}_{0}}}^{{k}_{l}} {p}_{y} ( y ( k ) ) ln \vert \frac{{p}_{y} ( y ( k ) )}{{\prod }_{j = l}^{j = r} {p}_{{y}_{j}} ( {y}_{j} ( k ) )} \vert$$

Here p_{y}(y) is the probability density function of the random vector y and p_{y}_{ⱼ}(yⱼ) is the probability density of the j^{th} component of the output vector y. The functional L(y) is always non-negative and is zero if and only if the components of the random vector y are statistically independent. This measure defines the degree of dependence among the components of the signal vector. Therefore, it represents an appropriate function for characterizing a degree of statistical independence. L(y) can be expressed in terms of the entropy:

$$L ( y ) = - H ( y ) + {\sum }_{i} H ( {y}_{i} )$$

Where H(•) is the entropy of y defined as H(y)=−E[Inf_{y}] and E[•] denotes the expected value.

Mixing environment 42 can be modeled as the following nonlinear discrete-time dynamic (forward) processing model:

X ₚ (k+1)=fₚ^{k} (Xₚ (k), s (k), w₁*)

m (k)=gₚₖ (Xₚ (k), s (k), w₂*)

Where s(k) is an n-dimensional vector of original sources, m(k) is the m-dimensional vector of measurements and Xₚ(k) is the Nₚ-dimensional state vector. The vector (or matrix) w₁* represents constants or parameters of the dynamic equation and w₂* represents constants or/parameters of the output equation. The functions fₚ(•) and gₚ(•) are differentiable. It is also assumed that existence and uniqueness of solutions of the differential equation are satisfied for each set of initial conditions Xₚ(t₀) and a given waveform vector s(k).

Voice extractor 26 may be represented by a dynamic feedforward network or a dynamic feedback network. The feedforward network is:

X (k+1)=f^{k} (X (k), m (k), w1)

y (k)=g^{k} (X (k), m (k), w2)

Where k is the index, m(k) is the m-dimensional measurement, y(k) is the r-dimensional output vector, and X(k) is the N-dimensional state vector. Note that N and Nₚ may be different. The vector (or matrix) W₁ represents the parameter of the dynamic equation and the vector (or matrix) W₂ represents the parameter of the output equation. The functions f(•) and g(•) are differentiable. It is also assumed that existence and uniqueness of solutions of the differential equation are satisfied for each set of initial conditions X(t₀) and a given measurement waveform vector M(k).

The update law for dynamic environments is used to recover the original signals. Environment 42 is modeled as a linear dynamical system. Consequently, voice extractor 26 will also be modeled as a linear dynamical system.

In the case where voice extractor 26 is a feedforward dynamical system, the performance index may be defined as follows:

$${J}_{0} ( {w}_{1} , {w}_{2} ) = {\sum }_{k = {k}_{0}}^{{k}_{1} - 1} {L}^{k} ( {y}_{k} )$$

Subject to the discrete-time nonlinear dynamic network

Xₖ₊₁=f^{k} (Xₖ, Mₖ, W₁), Xₖ_{₀}

Yₖ=g^{k} (Xₖ, Mₖ, W₂)

This form of a general nonlinear time varying discrete dynamic model includes both the special architectures of multilayered recurrent and feedforward neural networks with any size and any number of layers. It is more compact, mathematically, to discuss this general case. It will be recognized by one of ordinary skill in the art that it may be directly and straightforwardly applied to feedforward and recurrent (feedback) models.

The augmented cost function to be optimized becomes:

$${J}_{0}^{′} ( {w}_{1} , {w}_{2} ) = {\sum }_{k = {k}_{0}}^{{k}_{1} - 1} {L}^{k} ( {y}_{k} ) + {λ}_{k + 1}^{T} ( {f}^{k} ( {X}_{k} , {m}_{k} , {w}_{1} ) - {X}_{k + 1} )$$

The Hamiltonian is then defined as:

H^{k}=L^{k} (y(k))+λₖ₊₁^{T}f^{k} (X, m, w₁)

Consequently, the necessary conditions for optimality are:

$${X}_{k + 1} = \frac{\partial {H}^{k}}{\partial {λ}_{k + 1}} = {f}^{k} ( {X}_{k} , {m}_{k} , {w}_{1} )$$

$${λ}_{k} = \frac{\partial {H}^{k}}{\partial {X}_{k}} = {( {f}_{{X}_{k}}^{k} )}^{T} {λ}_{k + 1} + \frac{\partial {L}^{k}}{\partial {X}_{k}}$$

$$Δ {w}_{2} = - η \frac{\partial {H}^{k}}{\partial {w}_{2}} = - η \frac{\partial {L}^{k}}{\partial {w}_{2}}$$

$$Δ {w}_{1} = - η \frac{\partial {H}^{k}}{\partial {w}_{1}} = - {( η ( {f}_{{w}_{1}}^{k} ) )}^{T} {λ}_{k + 1}$$

The boundary conditions are as follows. The first equation, the state equation, uses an initial condition, while the second equation, the co-state equation, uses a final condition equal to zero. The parameter equations use initial values with small norm which may be chosen randomly or from a given set.

In the general discrete linear dynamic case, the update law is then expressed as follows:

$${X}_{k + 1} = \frac{\partial {H}^{k}}{\partial {λ}_{k + 1}} = {f}^{k} ( X , m , {w}_{1} ) = A {X}_{k} + B {m}_{k}$$

$${λ}_{k} = \frac{\partial {H}^{k}}{\partial {X}_{k}} = {( {f}_{{X}_{k}}^{k} )}^{T} {λ}_{k + 1} + \frac{\partial {L}^{k}}{\partial {X}_{k}} = {A}_{k}^{T} {λ}_{k} + {C}_{k}^{T} \frac{\partial {L}^{k}}{\partial {y}_{k}}$$

$$Δ C = - η \frac{\partial {H}^{k}}{\partial C} = - η \frac{\partial {L}^{k}}{\partial C} = η ( - {f}_{a} ( y ) {X}^{T} )$$

$$Δ D = - η \frac{\partial {H}^{k}}{\partial D} = - η \frac{\partial {L}^{k}}{\partial D} = η ( {[ D ]}^{- T} - {f}_{a} ( y ) {m}^{T} )$$

$$Δ B = - η \frac{\partial {H}^{k}}{\partial B} = - {( η ( {f}_{B}^{k} ) )}^{T} {λ}_{k + 1} = - {ηλ}_{k + 1} {m}_{k}^{T}$$

$$Δ A = - η \frac{\partial {H}^{k}}{\partial A} = - {( η ( {f}_{A}^{k} ) )}^{T} {λ}_{k + 1} = - {ηλ}_{k + 1} {X}_{k}^{T}$$

The general discrete-time linear dynamics of the network are given as:

X (k+1)=A X (k)+Bm (k)

y (k)=C X (k)+Dm (k)

Where m(k) is the m-dimensional vector of measurements, y(k) is the n-dimensional vector of processed outputs, and X(k) is the (mL) dimensional states (representing filtered versions of the measurements in this case). One may view the state vector as composed of the L m-dimensional state vectors X₁,X₂, . . . , X_{L}. That is,

$${X}_{k} = X ( k ) = [ \begin{matrix}{X}_{1} ( k ) \\ {X}_{2} ( k ) \\ … \\ {X}_{L} ( k )\end{matrix} ]$$

In the case where the matrices and A and B are in the controllable canonical form, the A and B block matrices may be represented as:

$$A = [ \begin{matrix}{A}_{11} & {A}_{12} & … & {A}_{1 L} \\ I & 0 & … & 0 \\ … & I & … & 0 \\ 0 & 0 & I & 0\end{matrix} ] , and B = [ \begin{matrix}I \\ 0 \\ … \\ 0\end{matrix} ]$$

Where each block sub-matrix A₁ⱼ may be simplified to a diagonal matrix, and each I is a block identity matrix with appropriate dimensions.

Then:

$${X}_{1} ( k + 1 ) = {\sum }_{j = 1}^{L} {A}_{{1}_{j}} {X}_{j} ( k ) + m ( k )$$

X₂ (k+1)=X₁ (k)

X_{L} (k+1)=X_{L-1} (k)

$$y ( k ) = {\sum }_{j = 1}^{L} {C}_{j} {X}_{j} ( k ) + Dm ( k )$$

This model represents an IIR filtering structure of the measurement vector m(k). In the event that the block matrices A₁ⱼ are zero, the model is reduced to the special case of an FIR filter.

X₁ (k+1)=m (k)

X₂ (k+1)=X₁ (k)

X_{L} (k+1)=X_{L-1} (k)

$$y ( k ) = {\sum }_{j = 1}^{L} {C}_{j} {X}_{j} ( k ) + Dm ( k )$$

The equations may be rewritten in the well-known FIR form:

X₁ (k)=m (k−1)

X₂ (k)=X₁ (k−1)=m (k −2)

X_{L} (k)=X_{L-1} (k−1)=m (k−L)

$$y ( k ) = {\sum }_{j = 1}^{L} {C}_{j} {X}_{j} ( k ) + Dm ( k )$$

This equation relates the measured signal m(k) and its delayed versions represented by Xⱼ(k), to the output y(k).

The matrices A and B are best represented in the controllable canonical forms or the form I format. Then B is constant and A has only the first block rows as parameters in the IIR network case. Thus, no update equations for the matrix B are used and only the first block rows of the matrix A are updated. Thus, the update law for the matrix A is as follows:

$$Δ {A}_{1 j} = - η \frac{\partial {H}^{k}}{\partial {A}_{1 j}} = - {η ( {f}_{{A}_{1 j}}^{k} )}^{T} {λ}_{k + 1} = - {ηλ}_{1} ( k + 1 ) {X}_{j}^{T} ( k )$$

Noting the form of the matrix A, the co-state equations can be expanded as:

$${λ}_{1} ( k ) = {λ}_{2} ( k + 1 ) + {C}_{1}^{T} \frac{\partial {L}^{k}}{\partial {y}_{k}} ( k )$$

$${λ}_{2} ( k ) = {λ}_{3} ( k + 1 ) + {C}_{2}^{T} \frac{\partial {L}^{k}}{\partial {y}_{k}} ( k )$$

$$⋮$$

$${λ}_{L} ( k ) = {C}_{L}^{T} \frac{\partial {L}^{K}}{\partial {y}_{k}} ( k )$$

$${λ}_{1} ( k + 1 ) = {\sum }_{l = 1}^{L} {C}_{l}^{T} \frac{\partial {L}^{k}}{\partial {y}_{k}} ( k + l )$$

Therefore, the update law for the block sub-matrices in A are:

$$Δ {A}_{1 j} = - η \frac{\partial {H}^{k}}{\partial {A}_{1 j}} = - {ηλ}_{1} ( k + 1 ) {X}_{j}^{T} ( K ) = - η {\sum }_{l = 1}^{L} {C}_{l}^{T} \frac{\partial {l}^{k}}{\partial {y}_{k}} ( k + l ) {X}_{j}^{T}$$

The update laws for the matrices D and C can be expressed as follows:

AD=η([D]^{-T}−fₐ(y)m^{T})=η(I−fₐ(y)(Dm)^{T})[D]^{-T}

Where I is a matrix composed of the r×r identity matrix augmented by additional zero row (if n>r) or additional zero columns (if n<r) and [D]^{-T} represents the transpose of the pseudo-inverse of the D matrix.

For the C matrix, the update equations can be written for each block matrix as follows:

$$Δ {C}_{j} = - η \frac{\partial {H}^{k}}{\partial {C}_{j}} = - η \frac{\partial {L}^{k}}{\partial {C}_{j}} = η ( - {f}_{a} ( y ) {X}_{j}^{T} )$$

Other forms of these update equations may use the natural gradient to render different representations. In this case, no inverse of the D matrix is used. However, the update law for ΔC becomes more computationally demanding.

If the state space is reduced by eliminating the internal state, the system reduces to a static environment where:

m (t)=\overline{D} S (t)

In discrete notation, the environment is defined by:

m (k)=\overline{D} S (k)

Two types of discrete networks have been described for separation of statically mixed signals. These are the feedforward network, where the separated signals y(k) 46 are

y(k)=W M(k)

And feedback network, where y(k) 46 is defined as:

y (k)=m (k)−Dy (k)

y (k)=(I+D)⁻¹m (k)

In case of the feedforward network, the discrete update laws are as follows:

W^{t+1}=W¹+μ{−f (y(k)) g^{T} (y(k))+αI}

And in case of the feedback network,

D^{t+1}=D^{t}+μ{f (y(k))g^{T} (y(k))−αI}

Where (αI) may be replaced by time windowed averages of the diagonals of the f(y(k)) g^{T}(y(k) ) matrix. Multiplicative weights may also be used in the update.

Output separated signals y(k) 46 represent signal sources s(k) 40. As such, at least one component of vector y(k) 46 is extracted speech signal 28 and at least one component of vector y(k) 46 is extracted noise signal 30. Many extracted speech signals 28 may be simultaneously generated by voice extractor 26. Speech detector 32 may treat each of these as a signal of interest and the remaining as extracted noise signals 30 to generate a plurality of detected speech signals 24.

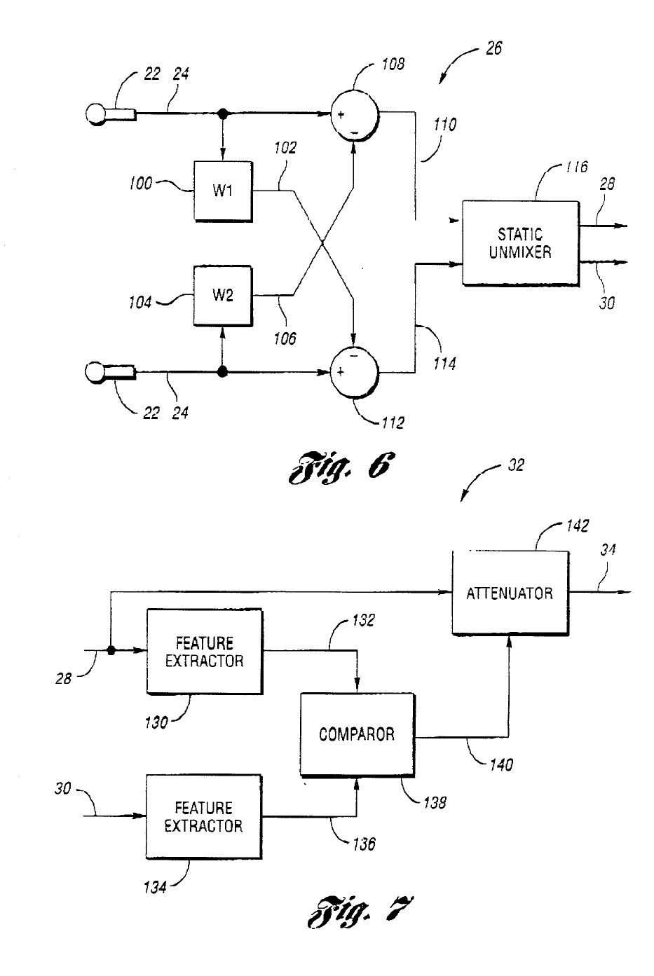

Referring now to FIG. 5, a block diagram illustrating a two transducer voice extractor having a plurality of extracted speech signal outputs according to an embodiment of the present is shown. First extracted speech signal 60 and extracted noise signal 30 provide inputs for voice extract system 62. Voice extract system 62 uses inter-microphone differential information and the statistical properties of independent signal sources to distinguish between audio signals. Algorithms used embody multiple nonlinear mathematical equations that capture the non-linear characteristics and inherent ambiguity in distinguishing between mixed signals in real environments.

Voice extract system 62 generates first output 64 and second output 66. Summer 68 combines sound signal 24 from first microphone (m₁) 22 and second output 66 to produce first extracted speech signal 60. Summer 70 combines sound signal 24 from second microphone (m₂) 22 with first output 64 to generate extracted noise signal 30.

Three other extracted speech signals 28 are also provided. Second extracted speech signal 72 is generated by summer 74 as the difference between sound signal 24 from microphone m₂ 22 and extracted noise signal 30. To produce third extracted sound signal 76, extracted noise signal 30 is passed through adaptive least-mean-square (LMS) filter 78. Summer 80 generates third extracted sound signal 76 as the difference between sound signal 24 from microphone m₂ 22 and filtered extracted noise signal 82. Similarly, fourth extracted sound signal 84 is based on extracted noise signal 30 filtered by adaptive LMS filter 86. Summer 88 generates fourth extracted sound signal 84 as the difference between sound signal 24 from microphone m₁ 22 and filtered extracted noise signal 90 from adaptive LMS filter 86.

Referring now to FIG. 6, a block diagram of a two transducer voice extractor generating one extracted speech signal and one extracted noise signal according to an embodiment of the present invention is shown. First filter (W1) 100 receives sound signal 24 from first microphone 22 and generates first filtered output 102. Similarly, second filter (W2) 104 receives sound signal 24 from second microphone 22 and generates second filtered output 106. Summer 108 subtracts second filtered output from sound signal 24 of first microphone 22 to produce first compensated signal 110. Summer 112 subtracts first filtered output 102 from sound signal 24 of second microphone 22 to produce second compensated signal 114. Static unmixer 116 accepts first compensated signal 110 and second compensated signal 114 and generates extracted speech signal 28 and extracted noise signal 30.

This implementation of voice extraction can be thought of as a means of undoing a mixing, which is not only instantaneous as in

$${mix}_{i} ( t ) = {\sum }_{j = 1}^{N} {a}_{ij} {signal}_{j} ( t )$$

Where aᵢⱼ is an entry of the static mixing matrix A, but also involves delayed versions of the signals which can be expressed mathematically as follows:

$${mix}_{i} ( t ) = {\sum }_{j = 1}^{N} {\int }_{0}^{∞} {a}_{ij} ( {t}^{′} ) {signal}_{j} ( t - {t}^{′} ) ⅆ {t}^{′}$$

In discrete interpretation of the above, the mixing matrix A, composed of entries aᵢⱼ, is no longer a single matrix, but a series of matrices A(t=τ) as follows:

$$mix ( t ) = {\sum }_{τ = 0}^{N} A ( τ ) signal ( t - τ )$$

Where mix and signal are vectors.

There is an element of instantaneous mixture in this expression, where τ=0, which is undone by static unmixer 116. The delayed elements of the mixings are undone by multitap filters W1 100 and W2 104.

Filter coefficients for W1 100, W2 104, and static unmixer 116 can be obtained adaptively, using a variety of criteria. One such criterion is the statistical independence of independent signal sources principle. However, instead of enforcing the constraint at a single time point (i.e., t=0), the adaptation enforces this criterion for all delayed versions (i.e., t=τ), as well. Voice extraction is thus performed by a feedback architecture that follows the equation:

$$y ( t ) = StaticUnmixer \{ [ mix ( t ) - {\sum }_{i = 1}^{N} {W}_{i} y ( t - i ) ] \}$$

Where y(t) is the output vector containing extracted speech signal 28 and extracted noise signal 30, mix(t) is the input vector of sound signals 24, and Wᵢ are delayed tap matrices for filters 100, 104, both having zero-diagonals. The filters Wᵢ 100, 104 subtract off delayed versions of the interfering signals.

Static unmixer 116 can be an operator, which involves a matrix multiplication operation reduced to a filter, such as the following:

$$y ( t ) = {( I + D )}^{- 1} [ mix ( t ) - {\sum }_{i = 1}^{N} {W}_{i} y ( t - i ) ]$$

Where I is the identity matrix, D is another matrix with zero diagonals.

Assuming a two-input, two-output system, adaptation of the off-diagonal entries of the 2×2 matrices D and Wᵢ can be defined by the following equations:

$$Δ D = η [ \begin{matrix}0 & f ( {y}_{1} ( t ) ) g ( {y}_{2} ( t ) ) \\ f ( {y}_{2} ( t ) ) g ( {y}_{1} ( t ) ) & 0\end{matrix} ]$$

$$Δ {W}_{i} = η [ \begin{matrix}0 & f ( {y}_{1} ( t ) ) g ( {y}_{2} ( t - i ) ) \\ f ( {y}_{2} ( t ) ) g ( {y}_{1} ( t - i ) ) & 0\end{matrix} ]$$

Where η is the rate of adaptation, yᵢ(t) is the scalar output yᵢ at time t, and f(x) and g(x) are functions with certain mathematical properties. As will be recognized by one of ordinary skill in the art, these functions and various filter coefficients depend on a variety of variables, including the type and relative placement of transducers 22, type and level of noise expected, sampling rate, application, and the like.

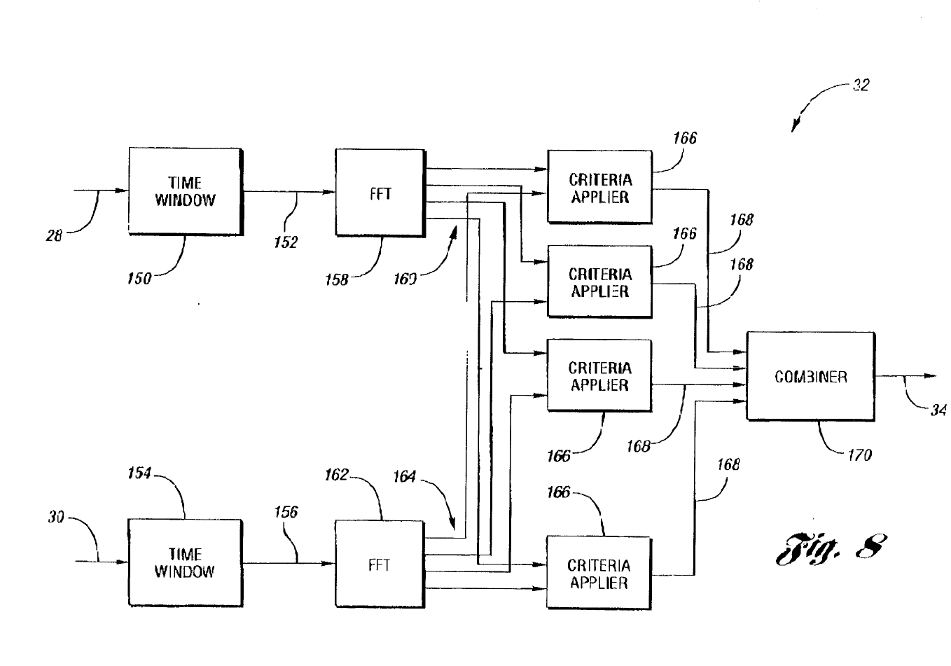

Referring now to FIG. 7, a block diagram illustrating a voice detector according to an embodiment of the present invention is shown. Voice detector 32 includes speech feature extractor 130 receiving one or more extracted speech signals 28 and generating one or more speech signal properties 132. Noise feature extractor 134 receives one or more extracted noise signals 30 and generates one or more noise signal properties 136. As will be described in greater detail below, properties 132, 136 can convey any information about extracted speech signals 28 and extracted noise signals 30, respectively. For example, properties 132, 136 may include one or more of signal powers, statistical properties, spectral properties, envelope properties, proximity between transducers 22, and the like. For example, extracted signals 28, 30 may be smoothed to produce signal envelopes and at least one property extracted from each envelope, such as local peaks or valleys, averages, threshold crossings, statistical properties, model fitting values, and the like. One or more properties used for speech signal property 132 may be the same as or correspond with properties used for noise signal property 136.

Comparor 138 generates at least one detection parameter 140 based on speech signal properties 132 and noise signal properties 136. Comparor 138 may operate in a variety of manners. For example, comparor 138 may generate detection parameter 140 as a mathematical combination of speech signal property 132 and noise signal property 136 such as, for example, a difference or a ratio. The result of this operation may be output directly as detection parameter 140, may be scaled to produce detection parameter 140, or detection parameter 140 may be a binary value resulting from comparing the operation results to one or more threshold values.

Attenuator 142 attenuates extracted speech signals 28 based on detection parameter 140 to produce detected speech signal 34. Detected speech signal 34 may also include detection parameter 140 as an indication of whether or not speech is present in extracted speech signal 28.

Referring now to FIG. 8, a block diagram illustrating a voice detector using multiple frequency bands according to an embodiment of the present invention is shown. Speech detector 32 includes time windower 150 accepting one or more extracted speech signals 28 and producing windowed speech signals 152. Similarly, time windower 154 accepts one or more extracted noise signals 30 and produces windowed noise signals 156. Windowing operations performed by windowers 150, 154 may be overlapping or non-overlapping and may implement a variety of windowing filters such as, for example, Hanning filters, Hamming filters, and the like.

Frequency converter 158 generates speech frequency bands, shown generally by 160, from windowed speech signal 152. Similarly, frequency converter 162 generates noise frequency bands, shown generally by 164, for each windowed noise signal 156. Frequency converters 158, 162 may implement any algorithm which generates spectral information from windowed signals 152, 156, respectively. For example, frequency converter 158, 162 may implement a fast Fourier transform (FFT) algorithm.

For each speech frequency band 160, criteria applier 166 accepts one speech frequency band 160 and a corresponding noise frequency band 164 and generates frequency band output 168 based on at least one detection parameter. Each detection parameter is based on at least one property of speech frequency band 160 and on corresponding noise frequency band 164. Any property of speech frequency band 160 or noise frequency band 164 may be used. Such properties include in-band power, magnitude properties, phase properties, statistical properties, and the like. For example, frequency band output 168 may be based on the ratio of in-band speech signal power to in-band noise signal power. Frequency band output 168 may include speech frequency band 160 scaled by the ratio of speech in-band power to noise in-band power. Alternatively, frequency band output 168 may attenuate speech frequency band 160 if the in-band signal-to-noise ratio is below a threshold.

Combiner 170 combines frequency band output 168 for each speech frequency band 160 to generate detected speech signal 34. In one embodiment, combiner 170 performs inter-band filtering followed by an inverse-FFT to generate detected speech signal 34. Alternatively or in combination, combiner 170 examines each frequency band output 168 and generates detected speech signal 34 indicating the likelihood that speech is present.

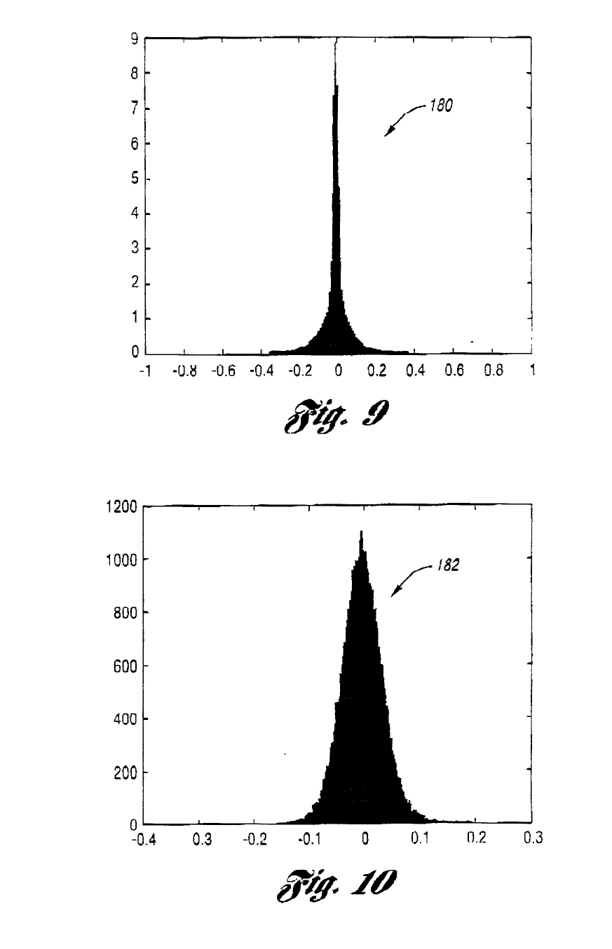

Referring now to FIGS. 9 and 10, histogram plots of a typical voice signal and a typical noise signal, respectively, are shown. Voice signals tend to have Laplacian probability distribution, such as shown in voice signal histogram plot 180. Noise signals, on the other hand, tend to have a Gaussian or Super-Gaussian probability distribution, such as seen in noise signal histogram plot 182. Thus, voice signals can be said to be of lower variance. The variance of extracted speech signal 28 or speech frequency bands 160 may be used to determine the presence of voice. Various other statistical measures, such as kirtosis, standard deviation, and the like, may be extracted as properties of speech and noise signals or frequency bands.

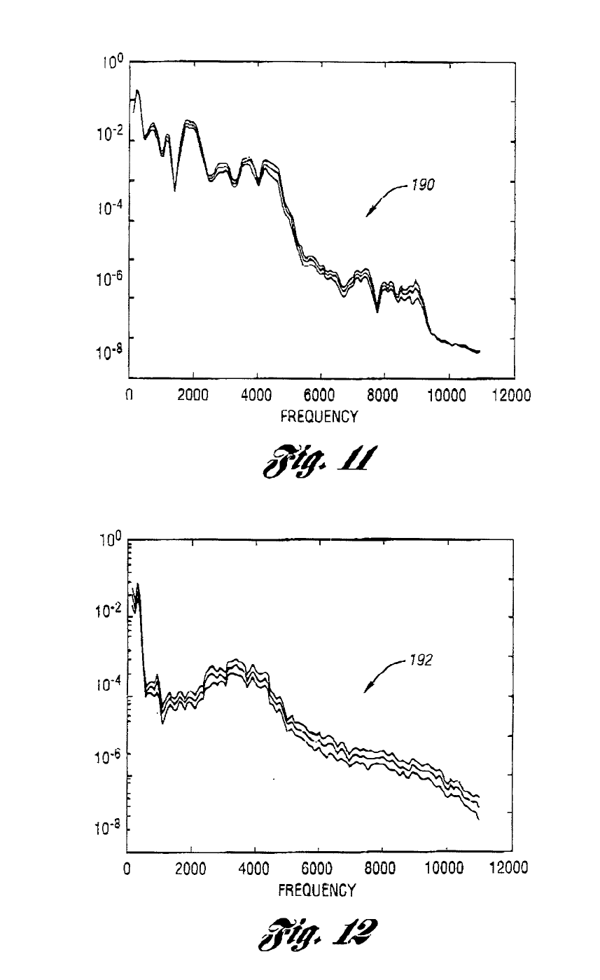

Referring now to FIGS. 11 and 12, frequency plots of a typical voice signal and a typical noise signal, respectively, are shown. The spectrum for speech, such as shown by voice power spectral density 190, is different then for noise, shown by noise power spectral density plot 192. Voice signals tend to have a narrower band width with pronounced peaks at formants. In contrast, most noise generally has a broader bandwidth. Various spectral techniques are possible. For example, one or more estimated bandwidth may be used. Statistical characteristics of the magnitude spectrum may also be extracted. Further, frequency spectrums 190, 192 may be used to derive parameters of a model. These parameters would then serve as signal properties.

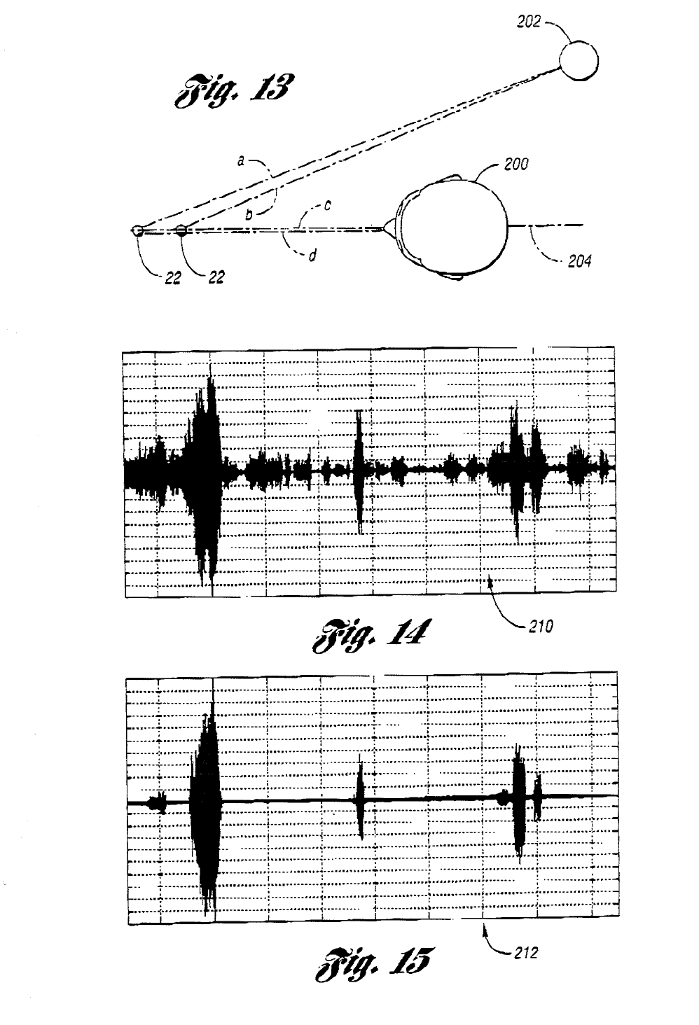

Referring now to FIG. 13, a schematic diagram illustrating relative transducer placement for a proximity-based speech detection according to an embodiment of the present invention is shown. Sources of voice signals, such as speaker 200, tend to be closer to transducers 22 then noise sources 202. This is true, for example, if user 200 is holding a palm top device at arms length. A microphone 22 on the palm top device is much closer to voice source 200 while one or more interfering noise sources 202 are usually much further away. Other effects of proximity may be evident in the presence of echos. Echos of a signal that is close to transducer 22 will be weaker then echos of sound sources far away. Still other effects of proximity may emerge when more then one transducer 22 are used. For signal sources that are close to multiple transducers 22, the difference in amplitude between transducers 22 will be more pronounced then signals that are further away. The arrangement of transducers 22 may be organized to amplify this effect. For example, two transducers 22 may be aligned with speaker 200 along axis 204. For any noise source 202 off of axis 204, the ratio of path lengths a,b from noise source 202 to transducers 22 will be less then the ratio of path lengths c,d from speaker 200 to transducers 22. This effect is exaggerated by the fact that sound decreases as the square of the distance. Thus, sound signal 24 from microphone 22 closer to speaker 200 is“speechier” and sound signal 24 from microphone 22 farther from speaker 200 is“noisier” by way of the arrangement of microphones 22.

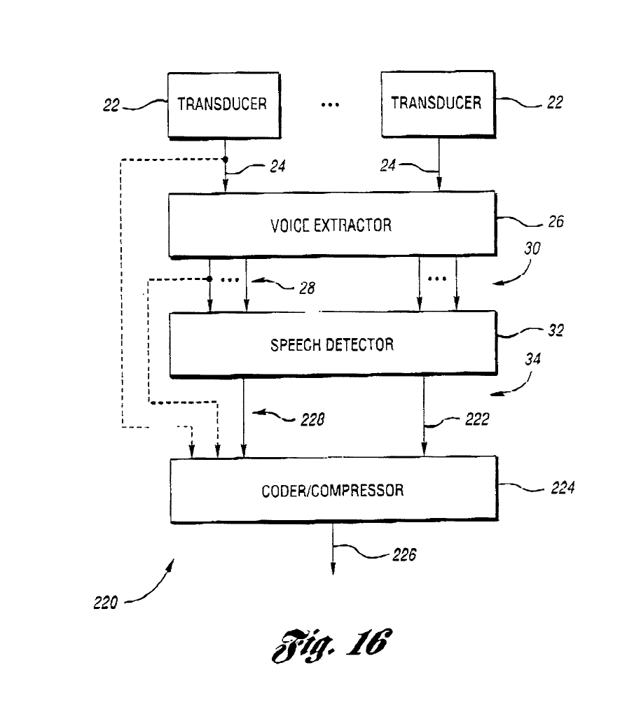

Referring now to FIGS. 14 and 15, plots of a noisy speech signal and a speech detected signal according to an embodiment of the present invention, respectively, are shown. Noisy signal 210 contains periods of noise information between speech utterances. Speech detected signal 212 has such noisy periods attenuated. Because silence may be coded or compressed at a lower rate then speech, the result may be used to reduce the number of bits needed to be stored or sent over a channel.

Referring now to FIG. 16, compressing or coding according to an embodiment of the present invention is shown. A coder/compressor system, shown generally by 220, includes speech detector 32 generating one or more detected speech signals 34. Detected speech signal 34 includes speech likelihood signal 222 expressing the likelihood that speech is present. Speech likelihood signal 222 may be a binary signal or may express some probability that speech has been detected by speech detector 32.

Coder/compressor 224 accepts speech likelihood signal 222 and generates coded or compressed signal 226 based on speech likelihood signal 222. Coder/compressor 224 also receives speech signal source 228 which may be an output of speech detector 32, extracted speech signal 28, or sound signal 24 from transducer 22. Coder/compressor 224 variably encodes and/or compresses speech signal source 228 based on speech likelihood signal 222. Thus, coded/compressed signal 226 requires substantially fewer bits. This may result in a wide variety of benefits including less bandwidth required, less storage required, greater data accuracy, greater information throughput, and the like.

While embodiments of the invention have been illustrated and described, it is not intended that these embodiments illustrate and describe all possible forms of the invention. The words of the specification are words of description rather then limitation, and it is understood that various changes may be made without departing from the spirit and scope of the invention.

Many embodiments have been shown in block diagram form for ease of illustration. However, one of ordinary skill in the art will recognize that the present invention may be implemented in any combination of hardware and software and in a wide variety of devices such as computers, digital signal processors, custom integrated circuits, programmable logic devices, analog components, and the like. Further, blocks may be logically combined or further subdivided to suit a particular implementation.

What is claimed is:

1. A speech detection system comprising:
at least one transducer converting sound into an electrical signal;
a voice extractor in communication with the at least one transducer, the voice extractor producing at least one extracted speech signal and at least one extracted noise signal based on at least one electrical sound signal; and
a speech detector in communication with the voice extractor, the speech detector generating a detected speech signal based on the at least one extracted speech signal and on the at least one extracted noise signal.

2. A speech detection system as in claim 1 wherein the speech detector recognizes periods of speech based on at least one property of the at least one extracted speech signal and on at least one corresponding property of the at least one extracted noise signal.

3. A speech detection system as in claim 1 wherein the speech detector recognizes periods of speech based on statistical properties of the at least one extracted speech signal and on statistical properties of the at least one extracted noise signal.

4. A speech detection system as in claim 1 wherein the speech detector recognizes periods of speech based on spectral properties of the at least one extracted speech signal and on spectral properties of the at least one extracted noise signal.

5. A speech detection system as in claim 1 wherein the at least one transducer is a plurality of transducers, the speech detector recognizing periods of speech based on estimated relative proximity of a speaker to at least two of the plurality of transducers.

6. A speech detection system as in claim 1 wherein the speech detector recognizes periods of speech based on an envelope of the at least one extracted speech signal.

7. A speech detection system as in claim 1 wherein the at least one extracted speech signal is divided in time into a plurality of windows, the speech detector generating the detected speech signal based on determining whether or not speech is present in each window.

8. A speech detection system as in claim 7 wherein the at least one extracted speech signal is divided into a plurality of frequency bands, the speech detector determining whether or not speech is present in each frequency band for each window.

9. A speech detection system as in claim 8 wherein the detected speech signal is based on combining the determination for each frequency band for each window.

10. A speech detection system as in claim 1 further comprising a variable rate coder in communication with the speech detector, the variable rate coder changing a coding rate for coding the detected speech signal based on a determined presence of speech in the detected speech signal.

11. A speech detection system as in claim 1 further comprising a variable rate compressor in communication with the speech detector, the variable rate compressor changing a compression rate for compressing the detected speech signal based on a determined presence of speech in the detected speech signal.

12. A method of detecting speech in the presence of noise comprising:
receiving at least one signal containing speech mixed with noise;
extracting at least one extracted speech signal from the at least one received signal;
extracting at least one extracted noise signal from the at least one received signal; and
generating a detected speech signal based on the at least one extracted speech signal and the at least one extracted noise signal.

13. A method of detecting speech as in claim 12 wherein the detected speech signal comprises periods wherein the at least one extracted speech signal is attenuated.

14. A method of detecting speech as in claim 12 wherein the detected speech signal comprises a likelihood of speech presence.

15. A method of detecting speech as in claim 12 wherein generating the detected speech signal comprises comparing at least one statistical property from the at least one extracted speech signal with at least one corresponding statistical property from the at least one extracted noise signal.

16. A method of detecting speech as in claim 12 wherein generating the detected speech signal comprises comparing at least one spectral property from the at least one extracted speech signal with at least one corresponding spectral property from the at least one extracted noise signal.

17. A method of detecting speech as in claim 12 wherein receiving at least one signal comprises receiving one signal from each of a plurality of acoustic transducers.

18. A method of detecting speech as in claim 17 wherein generating the detected speech signal is based on relative proximities to a speaker of at least two of the acoustic transducers.

19. A method of detecting speech as in claim 12 wherein generating the detected speech signal comprises comparing at least one envelope property from the at least one extracted speech signal with at least one corresponding envelope property from the at least one extracted noise signal.

20. A method of detecting speech as in claim 12 further comprising dividing the at least one extracted speech signal in time into a plurality of windows, the speech detector generating a detected speech signal based on determining whether or not speech is present in each window.

21. A method of detecting speech as in claim 20 further comprising dividing the at least one extracted speech signal into a plurality of frequency bands, wherein generating a detected speech signal comprises determining whether or not speech is present in each frequency band.

22. A method of detecting speech as in claim 21 wherein generating the detected speech signal further comprises combining the determination for each frequency band for each window.

23. A method of detecting speech as in claim 12 further comprising determining a coding rate based on a determined presence of speech in the detected speech signal.

24. A method of detecting speech as in claim 12 further comprising determining a compression rate based on a determined presence of speech in the detected speech signal.

25. A method of detecting speech as in claim 12 wherein generating the detected speech signal comprises comparing at least one property of the extracted speech signal with at least one corresponding property of the at least one extracted noise signal.

26. A method of detecting speech comprising:
receiving at least one noise signal;
receiving at least one speech signal having a greater content of the speech than the at least one noise signal;
extracting at least one noise parameter from the at least one noise signal;
extracting at least one speech parameter from the at least one speech signal;
comparing the at least one speech parameter and the at least one noise parameter; and
detecting the presence of speech based on the comparison.

27. A method of detecting speech as in claim 26 wherein extracting at least one noise parameter comprises time windowing the received at least one noise signal and wherein extracting at least one speech parameter comprises time windowing the received at least one speech signal.

28. A method of detecting speech as in claim 27 wherein extracting at least one noise parameter comprises dividing the windowed at least one noise signal into a first plurality of frequency bands and wherein extracting at least one speech parameter comprises dividing the at least one windowed speech signal into second plurality of frequency bands.

29. A method of detecting speech as in claim 28 wherein comparing comprises comparing each noise signal frequency band with a corresponding speech signal frequency band.

30. A method of detecting speech as in claim 29 wherein detecting the presence of speech comprises detecting the presence of speech for each frequency band.

31. A method of detecting speech comprising:
receiving a noise signal;
receiving a speech signal having greater speech content than the noise signal;
dividing the speech signal into a plurality of speech frequency bands;
dividing the noise signal into a plurality of noise frequency bands, each noise frequency band corresponding to one of the speech frequency bands;
for each speech frequency band, calculating at least one detection parameter based on at least one property of the speech frequency band and on at least one property of the corresponding noise frequency band;
for each speech frequency band, generating a frequency band output based on the at least one detection parameter for the speech frequency band.

32. A method of detecting speech as in claim 31 wherein the at least one property of the speech frequency band comprises speech power in the speech frequency band and wherein the at least one property of the noise frequency band comprises noise power in the noise frequency band.

33. A method of detecting speech as in claim 32 wherein calculating at least one detection parameter for each speech frequency band comprises calculating a ratio of speech power in the speech frequency band to noise power in the corresponding noise frequency band.

34. A method of detecting speech as in claim 31 wherein generating a frequency band output comprises attenuating the speech frequency band based on the at least one detection parameter for the speech frequency band.

35. A method of detecting speech as in claim 31 further comprising combining the frequency band output for each speech frequency band.
